(19) United States
(12) Patent Application Publication
(10) Pub. No.: US 2025/0206213 A1
(43) Pub. Date: Jun. 26, 2025

(54) ADJUSTABLE HEADREST FOR SEATBACK

(71) Applicants: Hyundai Motor Company, Seoul (KR); Kia Corporation, Seoul (KR)

(72) Inventors: Xin Li, Shandong (CN); Kai Shang, Shandong (CN); Ji Hyun Kim, Hwaseong (KR); Jiaping Xia, Shandong (CN)

(21) Appl. No.: 18/790,998

(22) Filed: Jul. 31, 2024

(30) Foreign Application Priority Data
Dec. 22, 2023 (CN) 202311791290.1

(51) Int. Cl. B60N 2/818; B60N 2/80; B60N 2/865

(52) U.S. Cl. CPC B60N 2/818; B60N 2/865; B60N 2002/899

(57) ABSTRACT

Provided relates to an adjustable headrest for a seatback, comprising a body and an operating module. The operating module, connected to the body, drives it to move up, down, forward, and backward with respect to the seatback. It includes a locking/release module, a front/rear movement module, and an up/down movement guide rail module. The locking/release module controls the headrest's state, fixing it to the seatback in a locked state and allowing movement in a released state. The front/rear movement module enables forward and backward movement, while the up/down movement guide rail module allows vertical movement. Both modules are connected to the guide rail and are mounted inside the body, allowing multidirectional adjustment in the release state.

### CROSS-REFERENCE TO RELATED APPLICATION

This application claims under 35 U.S.C. § 119(a) the benefit of Chinese Patent Application No. 202311791290.1 filed in the Chinese National Intellectual Property Administration on Dec. 22, 2023, the entire contents of which are incorporated herein by reference.

### BACKGROUND

### Technical Field

The invention is an adjustable headrest for a seatback that can move up and down, and forward and backward. It includes a body and an operating module with three main components: a locking/release module, a front/rear movement module, and an up/down movement guide rail module. These components work together to control and allow the headrest's movement, ensuring it stays secure when locked and can be adjusted when released.

### Background

With the development trend of eco-friendly vehicles, vehicle seats are also evolving towards sportier and integrated seats. The integrated seat with an adjustable headrest design and function is suitable for accommodating a wider range of body types. At the same time, there is a similar demand for such adjustable headrest designs in other forms of transportation.

The preexisting technologies provide a design that can adjust the headrest up and down. Referring to FIG. 1, in the design, a driver A is mounted inside the headrest, two guide rods B are installed at a lower portion of the headrest and connected to fixation portions C mounted on the seatback, and a locking release portion D is mounted on one of the fixation portions C. When a height of the headrest needs to be adjusted, a user release the locking release portion D by pressing the locking release portion D with one hand, adjusts the headrest up or down at a predetermined height with the other one hand, and then locks the locking release portion D again, thereby adjusting the headrest.

When the headrest is used, the user should release or lock the locking release portion D by using two hands. In addition, the user can adjust the height up or down but cannot adjust the headrest forward or backward. Further, the guide rod B and the locking release portion D at the lower portion of the headrest are exposed to the outside, affecting the aesthetics.

Accordingly, the headrest in the prior art needs to be additionally improved. A new-structure headrest should be provided, which can be adjusted in four directions, up, down, forward, or backward, is easy to use, and has a beautiful structure.

The information of the background part of the present disclosure is only intended to understand the overall background of the present disclosure, and should not be considered to recognize or suggest that the information constitutes the prior art known to the technician in the field.

### SUMMARY

The present disclosure has been made in an effort to provide an adjustable headrest for a seatback which can adjust a headrest in four directions, up and down, and forward and backward.

The adjustable headrest for the seatback of the present disclosure can be conveniently adjusted only with one hand operation.

A design of the adjustable headrest for the seatback of the present disclosure is aesthetically pleasing.

In order to solve the technical problems, an exemplary embodiment of the present disclosure provides an adjustable headrest for a seatback. The headrest includes a body and an operating module. The operating module is connected to the body, and is configured to drive the body to move in up and down direction and forward and backward direction with respect to the seatback, and the operating module includes a locking/release module, a front/rear movement module, and an up/down movement guide rail module. The locking/release module is configured to control the state of the body with respect to the seatback such that, in a locking state, the body is fixed to the seatback, and in a release state, the body is allowed to move with respect to the seatback.

The front/rear movement module is configured to allow the body to move in the forward and backward direction.

The up/down movement guide rail module is mounted on the seatback, and the locking/release module and the front/rear movement module are connected to the up/down movement guide rail module to move in the up and down direction.

The locking/release module and the front/rear movement module are mounted inside the body such that in the release state the body is allowed to move in the up and down direction and the forward and backward direction through the locking/release module and the front/rear movement module.

The locking/release module includes a lower plate, a locking plate mounted on the lower plate and moving in left and right direction to lock the locking/release module to the up/down movement guide rail module, and a driving assembly provided on the lower plate and driving the locking plate to move.

A guide groove is provided on the lower plate, a concave facing downwards is provided at a middle portion of the lower plate, and a through-hole is provided on a bottom of the concave.

The locking plate includes a movement frame, a guide rod, and a locking rod, wherein the guide rod is mounted on the guide groove of the lower plate, and the locking rod is lockable to the up/down movement guide rail module.

The driving assembly includes a knob, a rotary shaft, a driving link, and a torsion spring. The knob is positioned below the concave of the lower plate, and the rotary shaft penetrates upwards through the through-hole of the concave. One end of the rotary shaft is fixedly connected to the knob, while the other end of the rotary shaft is fixedly connected to the driving link. A lever is provided on the end portion of the driving link opposite to the rotary shaft, and the lever is in contact with an inner side of the movement frame to push the movement frame to move the locking plate.

The up/down movement guide rail module includes a pair of fixation guide rails, each having a C-shaped cross-section, fixed onto the seatback, having a plurality of locking holes, and allowing the locking/release module to be locked with respect to the up/down movement guide rail module by inserting the locking rod into the locking hole, and a pair of movement guide rails mounted in the fixation guide rail, movable with respect to the fixation guide rail, and fixedly connected to the lower plate of the locking/release module and the front/rear movement module.

The up/down movement guide rail module further includes a first ball set provided between the fixation guide rail and the movement guide rail.

The first ball set may include a frame and a plurality of balls positioned at both sides of the frame.

The front/rear movement module is positioned above or below the locking/release module, and the front/rear movement module includes a cover plate, a locking pin, and a locking frame, wherein a concave groove is provided at a middle portion of the cover plate, and an opening is provided at a lower end of the concave groove, the locking pin and the locking frame are accommodated in the concave groove, the locking frame is one hollow frame and movable in the forward and backward direction with respect to the cover plate, a plurality of catching grooves is provided at one side of the locking frame, and both front and rear ends of the locking frame is fixedly connected to the headrest, and the locking pin is fitted into an outer side of the locking frame and movable in the left and right direction with respect to the locking frame, and a pin matching the catching groove of the locking frame is provided at one side of the locking pin.

The locking plate further includes a step portion, which is provided between the guide rod and the locking rod. A protrusion is provided on the lower side of the locking pin. The protrusion is matched with the step portion of the locking plate such that the locking pin is pushed in the left and right direction when the locking plate moves to allow the pin of the locking pin to be fitted into the catching groove of the locking frame or departed from the catching groove.

The front/rear movement module further includes a second ball set, and a rail matching the second ball set is provided at one or more of both upper and lower sides of the locking frame.

The second ball set may include a ball bracket and a ball.

The operating module further includes a frame, wherein the frame is mounted on the seatback and connected respectively to the frame of the seatback and the fixation guide rail.

The body includes a headrest covering and a front/rear inner cover. The headrest covering is provided on the outermost side of the body, while the front/rear inner cover is positioned on the inner side of the headrest covering. An accommodation space is formed inside the front/rear inner cover to accommodate the operating module, and the front/rear inner cover is connected to the front/rear movement module to move the headrest.

The adjustable headrest for the seatback of the present disclosure has the following beneficial effects.
(1) Various adjustment functions of an integrated seat can be implemented by improving a disadvantage of a conventional headrest adjustment scheme of the integrated seat.
(2) A locking/release scheme of the headrest in the related art is improved to make a seat function convenient.
(3) A fixation scheme of the headrest and a rear frame is optimized to maintain a movement feeling of the seat and implement an adjustment function of the headrest.

### BRIEF DESCRIPTION OF THE DRAWINGS

FIG. 1 illustrates a headrest for a seatback in the related art.

FIG. 2 illustrates an adjustable headrest for a seatback according to an exemplary embodiment of the present disclosure, in which a dotted line indicates a situation in which the headrest is adjusted up or down.

FIG. 3 illustrates an adjustable headrest for a seatback according to an exemplary embodiment of the present disclosure, in which a dotted line indicates a situation in which the headrest is adjusted forward or backward.

FIG. 4 illustrates a headrest mounted on the seatback and components thereof.

FIG. 5 is a front view of the headrest mounted on a seatback in which support portions at both left and right sides of the seatback are deleted.

FIG. 6 is a rear view of a headrest mounted on a seatback in which support portions at both left and right sides of the seatback are deleted.

FIG. 7A is an exploded view of a headrest.

FIG. 7B is a schematic view illustrating an assembled state of a headrest.

FIG. 7C is a schematic view illustrating components of a headrest.

FIG. 8A is a schematic view illustrating components of an operating module.

FIG. 8B is an exploded view of an operating module.

FIG. 9A is a schematic view illustrating an assembled state of a locking/release module.

FIG. 9B is a schematic view illustrating components of a locking/release module.

FIG. 10A is a side view of a locking/release module.

FIG. 10B is a plan view of a locking/release module.

FIG. 10C is a bottom view of a locking/release module, in which a locking rod is in a protruding state.

FIG. 10D is a bottom view of a locking/release module, in which a locking rod is in a contraction state.

FIG. 11A is a schematic view illustrating an assembled state of an up/down movement guide rail module.

FIG. 11B is an exploded view of an up/down movement guide rail module.

FIG. 12 is a schematic view illustrating a state in which a locking rod of a locking/release module is inserted into an up/down movement guide rail module.

FIG. 13A is a schematic view illustrating an assembled state of a front/rear movement module.

FIG. 13B is a schematic of components of a front/rear movement module.

FIG. 14A is a schematic view illustrating a state of a front/rear movement module, in which a locking pin is separated from a locking frame.

FIG. 14B is a schematic view illustrating a state of a front/rear movement module, in which a locking pin is fastened to a locking frame.

Unless otherwise explained, in the drawings, the same reference numerals represent the same element.

It should be understood that each of the characteristics is simply shown in the drawings in order to explain the basic principles of the present disclosure, and that the drawings are not necessarily drawn to scale. The specific design features disclosed in the present disclosure (for example, specific size, direction, position and shape) are partially determined according to the environment to be applied and used specifically.

In the drawings, the same reference numeral throughout a plurality of drawings represents the same or equal component of the present disclosure.

### DETAILED DESCRIPTION OF THE EMBODIMENTS

Hereinafter, each exemplary embodiment of the present disclosure will be referenced, and will hereinafter be described by illustrating the exemplary embodiments in the drawings. Although the present disclosure is described in conjunction with an exemplary embodiment, it should be understood that the present disclosure is not intended to be limited to such an exemplary embodiment. On the contrary, the present disclosure includes not only the exemplary embodiments, but also includes a variety of selection formats, modification formats, equivalent formats and other exemplary embodiments within the spirit of the present disclosure and the scope limited in the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

An adjustable headrest for a seatback according to an exemplary embodiment of the present disclosure is mounted on an upper portion of the seatback and can be adjusted up and down, and forward and backward with respect to a seat, so the headrest provides a headrest position which is convenient and appropriate for a passenger.

Up and down direction means upward or downward direction with respect to the seat back.

Left and right direction means a direction according to a width of the seatback.

Front and rear direction means a direction perpendicular to the up and down direction and the left and right direction, and is a direction approximately perpendicular to the seatback in a horizontal direction.

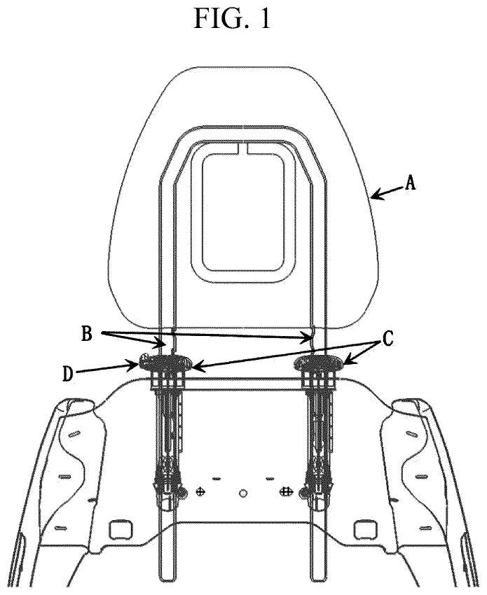

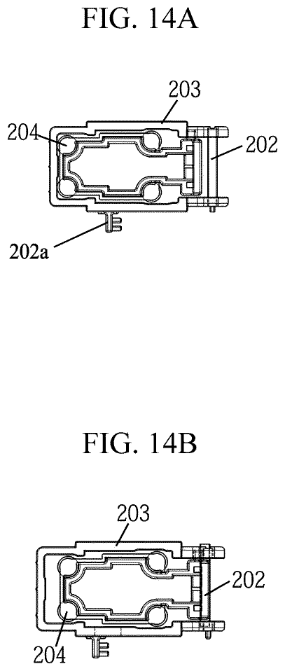

Hereinafter, an adjustable headrest for a seatback according to an exemplary embodiment of the present disclosure will be described with reference to FIGS. 1 to 14B.

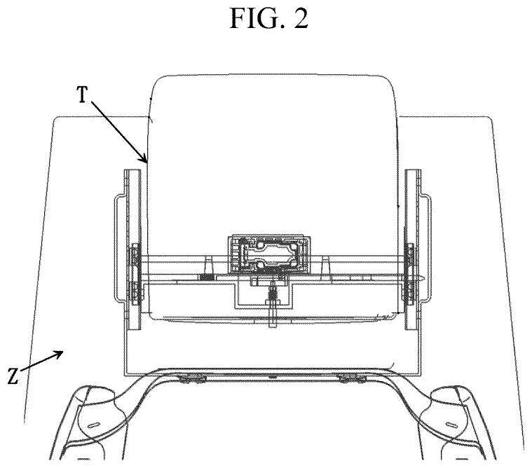

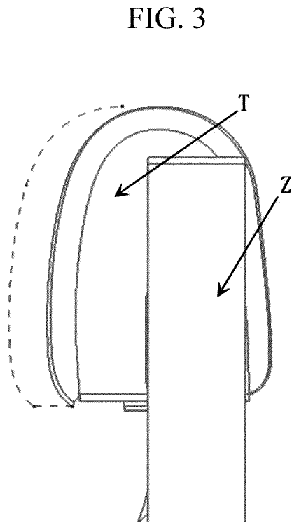

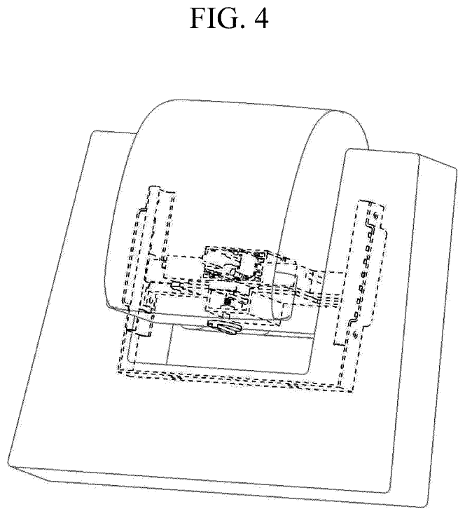

Referring to FIGS. 2 to 4, a headrest T according to an exemplary embodiment of the present disclosure is mounted on a seatback Z of a vehicle, support portions which protrude up are installed at both sides of an upper portion of the seatback Z, a concave groove is formed between two support portions, and the headrest T is mounted inside the concave groove to move in the up and down direction and the front and rear direction with respect to the seatback Z. In FIGS. 2 and 3, dotted lines indicate the adjustment position of the headrest T, showing that the headrest T may be adjusted in each of the up and down direction as well as the front and rear direction with respect to the seatback Z. FIG. 4 illustrates a situation in which the headrest T is mounted on the seatback Z.

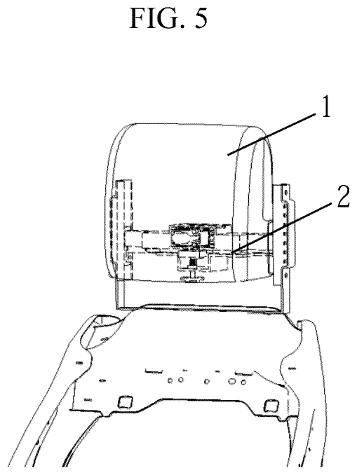

Referring to FIGS. 5, 6, and 7B, the adjustable headrest T for the seatback according to an exemplary embodiment of the present disclosure includes a body 1 and an operating module 2, and the operating module 2 is mounted on the body 1 and the seatback Z to allow the body 1 to move up or down, and forward or backward with respect to the seatback Z.

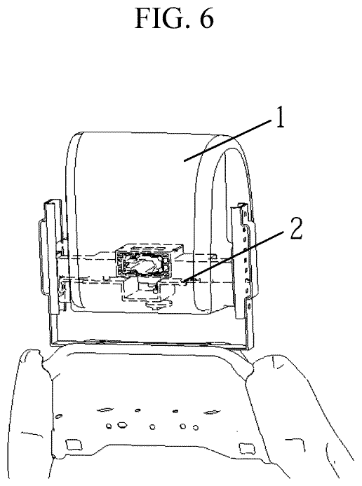

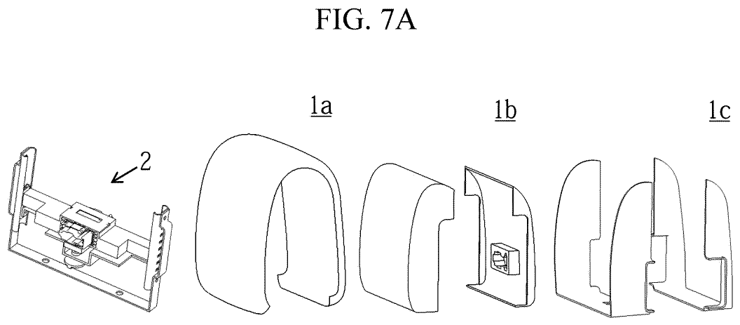

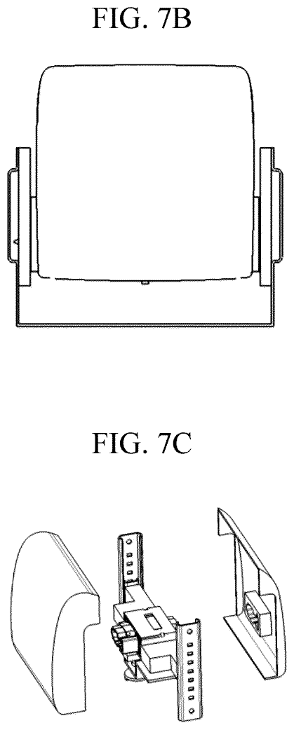

Referring to FIG. 7A, the body 1 includes a headrest covering 1a, a front/rear inner cover 1b, a front/rear lower cover 1c, and an external foam.

The headrest covering 1a is positioned on the outermost side of the headrest T, the front/rear inner cover 1b, the front/rear lower cover 1c, and the external foam are positioned inside the headrest covering 1a. The headrest covering 1a configures a design of an external appearance of the headrest T, and is generally made of a braid or leather material.

The front/rear inner cover 1b serves to separate the operating module 2 and the external foam. The front/rear inner cover 1b has an accommodation space therein to accommodate the operating module 2, and it is connected to a front/rear movement module 20 to enable the movement of the headrest.

The external foam is positioned between the headrest covering 1a and the front/rear inner cover 1b, and covers an exterior of the front/rear inner cover 1b to form a soft and convenient pad.

The front/rear lower cover 1c and the headrest covering 1a are assembled together.

In the exemplary embodiment, a specific structure of the body 1 is described, but those skilled in the art may modify and change the structure according to a specific need, and the modification and change of the structure do not influence a technical measure of the present disclosure.

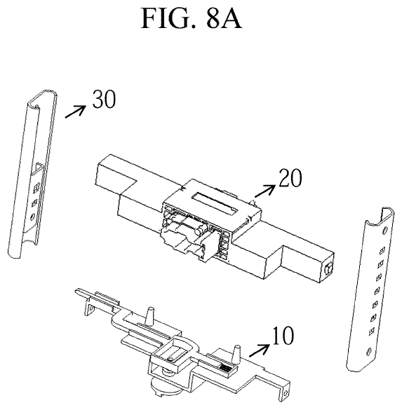

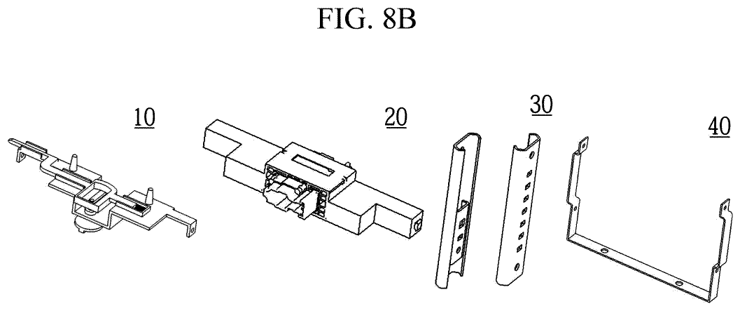

The operating module 2 drives up and down, and forward and backward movements of the headrest T, and controls locking and release of the headrest T. Referring to FIGS. 8A and 8B, the operating module 2 includes a locking/release module 10, a front/rear movement module 20, an up/down movement guide rail module 30, and a frame 40.

The locking/release module 10 is installed inside the body 1 of the headrest T. The locking/release module 10 allows the body 1 to be locked and remain stationary in a locking state, and it allows the body 1 to be adjusted in the up and down direction and the forward and backward direction with respect to the seatback Z in a release state.

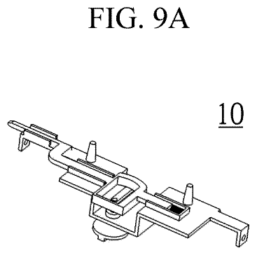

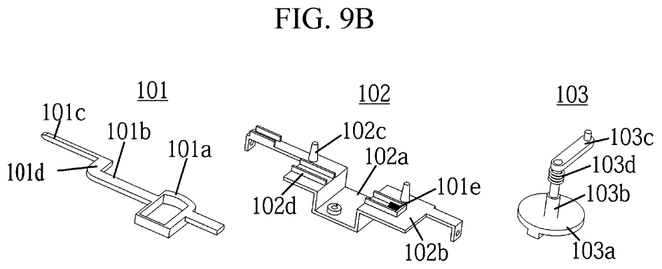

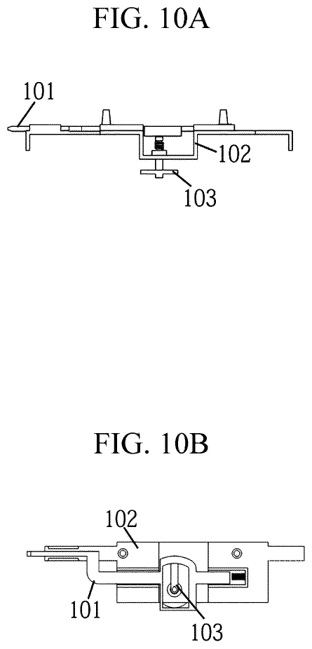

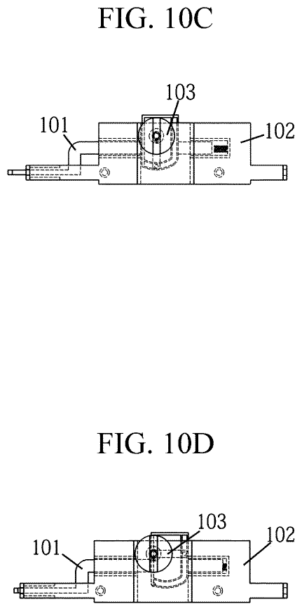

Referring to FIGS. 9A to 9B and FIGS. 10A to 10D, the locking/release module 10 includes a locking plate 101, a lower plate 102, and a driving assembly 103.

The lower plate 102 is used as a supporter of the locking/release module 10, and other members of the locking/release module 10 may be mounted on the lower plate 102, and moved with respect to the lower plate 102.

A concave 102a facing downward is provided at a middle portion of the lower plate 102, and a through-hole is provided on the bottom of the concave 102a. A rotary shaft 103b, a driving link 103c, etc., are all positioned in the concave.

An upper surface 102b of the lower plate 102 is stretched outward from both sides of the concave, and is provided with a pin 102c and a guide groove 102d.

The locking plate 101 may include a movement frame 101a, a guide rod 101b, a step portion 101d, and a locking rod 101c. The locking plate 101 may be mounted on the upper surface of the lower plate 102 and moved in the left and right direction with respect to the lower plate 102.

The movement frame 101a is an approximately rectangular frame, and one side of the movement frame 101a in the forward and backward direction has an arc shape.

The guide rod 101b is positioned on each of both sides of the movement frame 101a, and extends outwards in the left and right direction. Since the guide rod 101b is mounted in the guide groove 102d on the lower plate 102, the guide groove 102d guides the guide rods 101b when the locking plate 101 moves left or right. In the exemplary embodiment, the guide rod 101b is positioned at each of both sides of the movement frame 101a, but the guide rod 101b may also be provided only at one side of the movement frame 101a, i.e., one side at which the locking rod 101c is provided.

The step portion 101d is vertically bent from an end of the guide rod 101b to form one step portion.

The locking rod 101c is bent perpendicularly outwards from the step portion 101d and positioned on the outer side of the guide rod 101b in the left and right direction. The end portion of the locking rod 101c is inserted into a locking hole of a fixation guide rail 301 of the up/down movement guide rail module 30 when the locking/release module 10 is locked, which allows the locking/release module 10 to be fixed to the fixation guide rail 301. In one example, the end portion of the locking rod 10c may be equipped with a chamfer to be more easily inserted into the locking hole of the fixation guide rail 301. A part of the locking rod 101c is mounted on the guide groove of the lower plate 102 to be guided thereby.

A spring 101e may be installed at a right end portion of the locking plate 101, and as a result, restoration force toward the left is applied to the locking rod 101c to allow the locking rod to be restored to the locking state in which the locking rod 101c is inserted into the locking hole of the fixation guide rail 301.

The driving assembly 103 includes a knob 103a, the rotary shaft 103b, the driving link 103c, and a torsion spring 103d.

The knob 103a is positioned below the concave 102a of the lower plate 102. The knob 103a is rotated to convert the state of the locking/release module 10, allowing it to be either in the locking state or the release state.

The rotary shaft 103b penetrates upwards from the through-hole of the concave 102a. One end of the rotary shaft 103b is fixedly connected to the knob 103a, and the other end is fixedly connected to the driving link 103c.

A lever is provided on the end portion of the driving link 103c opposite to the rotary shaft 103b, and the lever is in contact with an inner side of the movement frame 101a to push the movement frame 101a to move the locking plate 101. Referring to FIGS. 10A to 10D, an arc radius of an arc portion of the movement frame 101a is matched with a length of the driving link 103c. When the knob 103a is rotated, the lever may be moved to the right side from the arc portion, and is in contact with a side surface positioned at the right side to push the side surface such that the movement frame 101a is moved to the right side and the locking/release module 10 is allowed to be in the release state.

The torsion spring 103d is installed on the rotary shaft 103b, two ends of the torsion spring 103d are caught in the driving link 103c and the lower plate 102, respectively, and applies restoration force toward the left (i.e., the locking state) to the driving link 103c such that when a user releases the knob 103a, the driving link 10c and the locking plate 101 may automatically return to the locking position.

The locking/release module 10 performs locking and release operations. When the lever is moved to the right by turning the knob 103a below the headrest T, both the locking/release module and the front/rear movement module may be simultaneously released.

In the exemplary embodiment, the locking plate 101 is installed only at one side of the lower plate 102. That is, the locking/release module 10 is locked to the fixation guide rail 301 positioned just at the left side. Optionally, the locking plate 101 may be locked by using the fixation guide rails at both sides. That is, the locking plate is added to the other side of the lower plate 102 of the locking/release module 10, and direction change is conducted through racks installed at sides of the guide rods of two locking plates and a gear positioned between two racks, or direction change is conducted by hinging two locking plates through a lever to lock the locking plates through the fixation guide rails on both left and right sides.

Referring to FIGS. 5, 6, and 8A, the front/rear movement module 20 is positioned above the locking/release module 10, and connected to the locking/release module 10 through a pin 102c of the locking/release module 10. The side surface of the front/rear movement module 20 is mounted on a movement guide rail 302, the front/rear movement module 20 is connected to the front/rear inner cover 1b, and the front/rear movement module 20 allows the headrest to move in the forward and backward direction and to move in the up and down direction with respect to the seatback together with the locking/release module 10, which also allows the headrest to move in the up and down direction.

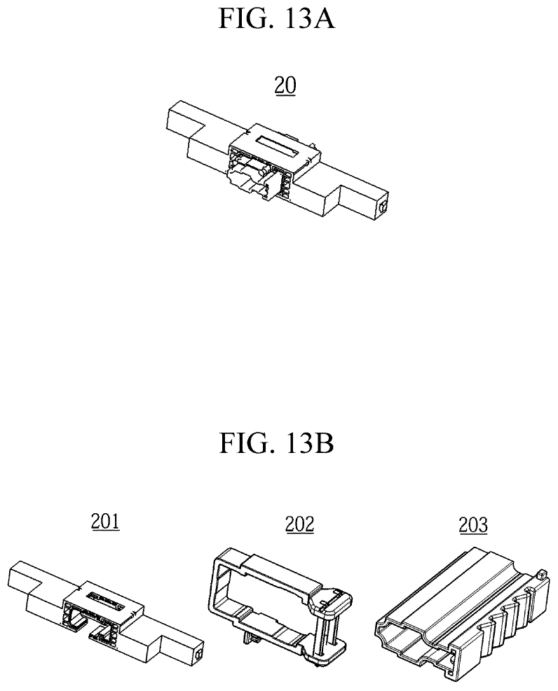

Referring to FIGS. 13A and 13B, the front/rear movement module 20 includes a cover plate 201, a locking pin 202, a locking frame 203, and a second ball set 204.

The cover plate 201 acts as the supporter of the front/rear movement module, and other members of the front/rear movement module 20 may be mounted on the cover plate 201 and moved with respect to the cover plate 201. A concave groove is provided at a middle portion of the cover plate 201, and an opening is provided at the lower end of the concave groove. The locking pin 202, the locking frame 203, and the second ball set 204 are all accommodated in the concave groove. Both left and right ends of the cover plate 201 is fixedly connected to the movement guide rail 302.

The locking frame 203 may be one hollow frame and may move in the forward and backward direction with respect to the cover plate 201. A cross section of the locking frame 203 is approximately quadrangular. Four rails matching balls of the second ball set 204 are installed at both upper and lower sides of the locking frame 203, respectively, and each rail is extended in the forward and backward direction. Further, a plurality of catching grooves is provided at one side (the right side in the drawing) of the locking frame 203.

Both front and rear ends of the locking frame 203 is fixedly connected to the front/rear inner cover 1b of the headrest T. When the locking frame 203 moves with respect to the cover plate 201, the locking frame 203 drives the headrest T to move in the forward and backward direction.

The locking pin 202 may be a roll type structure and may be fitted into the outer side of the locking frame 203 to move in the left and right direction with respect to the locking frame 203. A pin for matching the catching groove of the locking frame 203 is provided at one side of the locking pin 202, and the locking pin 202 and the locking frame 203 are caught in each other to lock the locking frame 203 with respect to the cover plate 201. In the exemplary embodiment, there are two pins but one or more pins may also be provided.

A protrusion 202a is provided at a lower side of the locking pin 202, and the protrusion 202a is inserted into the step portion 101d of the locking plate 101, so the locking plate 101 may be driven to move the locking frame 203. That is, when the locking plate 101 is moved to the right side and released, the step portion 101d also pushes the locking plate 202 to move through the protrusion 202a, causing the pin of the locking pin 202 to depart from the catching groove and release the locking frame 203. When the locking rod 101c is moved to the left side and locked, the locking pin 202 is also moved to the left side and the locking frame 203 is locked while the pin of the locking pin 202 is in contact with the catching groove.

A width of the locking pin 202 in the left and right-direction is larger than that of the locking frame 203. Accordingly, the locking pin 202 may move in the left and right direction with respect to the locking frame 203 to be switched between the locking state and the release state.

The second ball set 203 may be installed between the cover plate 201 and the locking frame 203 and positioned on the rail of the locking frame 203. The second ball set 203 may allow the locking frame 203 to be rolled forward and backward with respect to the cover plate 201. In the locking state, the locking pin 202 is caught in the locking frame 203 to prevent the locking frame 203 from moving forward and backward. In the release state, the locking pin 202 moves to the right side and decouples the locking pin 202 and the catching groove to allow the locking frame 203 to move forward and backward.

The second ball set 203 includes a ball bracket and a ball.

Optionally, the spring is further installed in the front/rear movement module 20 and pushes the locking pin 202 to the left side to return the locking pin 202 to the locking position.

In the exemplary embodiment, the front/rear movement module 20 may be positioned above the locking/release module 10. Optionally, the front/rear movement module 20 may also be positioned below the locking/release module 10. In this case, only partial adjustment of a connection relationship between the front/rear movement module 20 and the locking/release module 10 is required.

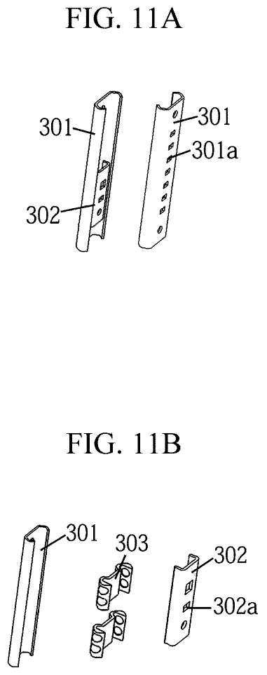

Referring to FIGS. 11A and 11B, the up/down movement guide rail module 30 includes a fixation guide rail 301. a movement guide rail 302, and a first ball set 303. The up/down movement guide rail module 30 is positioned inside the seatback Z, and specifically, positioned inside both upper support portions of the seatback Z.

Referring to FIGS. 5 and 6, there are a pair of fixation guide rails 301, a cross-sectional shape of the fixation guide rail 301 is a C shape, and the pair of fixation guide rails 301 is fixed to the frame 40 through a bolt. The fixation guide rail 301 is a groove type in which the opening faces the headrest T, and includes a plurality of locking holes in a transverse direction. These locking holes allow the end portion of the locking rod 101c of the locking/release module 10 to be inserted into the locking hole, thereby implementing locking of the headrest T. An interval between the neighboring locking holes may be set as necessary, which limits a distance in which the headrest T moves up and down.

The movement guide rail 302 may be a groove type in which the opening faces the support portion and may be mounted in the fixation guide rail 301 to move up and down with respect to the fixation guide rail 301. A through-hole is provided in the movement guide rail 302, and the locking plate 101 of the locking/release module 10 penetrates the through-hole to be inserted into the locking hole of the fixation guide rail 301. Both the locking/release module 10 and the front/rear movement module 20 are connected to the movement guide rail 302 and move up and down with respect to the fixation guide rail 301 through the movement guide rail 302. Specifically, the end of the lower plate 102 of the locking/release module 10 is fixed to the movement guide rail 302 through the bolt, and the end of the cover plate 201 of the front/rear movement module is also fixed to the movement guide rail 302 through the bolt.

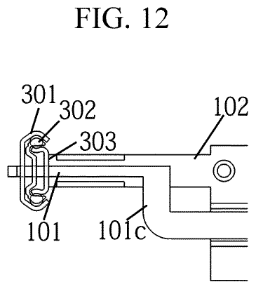

The first ball set 303 includes a frame and a plurality of balls positioned at both sides of the frame, and the first ball set 302 is provided between the fixation guide rail 301 and the movement guide rail 302 to provide rolling friction to the fixation guider rail 301 and the movement guide rail 302 such that the movement guide rail 302 and the fixation guide rail 301 are allowed to move up and down (see FIG. 12).

In the locking state, the locking plate 101 is inserted into the locking hole of the fixation guide rail 301 to lock the locking/release module 10 with respect to the fixation guide rail 301. When released, the locking plate 101 of the locking/release module 10 moves to the right side and then the locking between the movement guide rail 302 and the fixation guide rail 301 is released to allow the locking/release module 10 to move up and down.

Referring to FIGS. 5 and 6, the frame 40 is positioned outside the fixation guide rail 301. In an aspect, the frame 40 is fixed to the frame of the seatback Z through the bolt. In another aspect, the frame 40 and the fixation guide rail 310 are fixed to each other through the bolt, which allows the up/down movement guide rail module 30 to be mounted in the seatback Z.

Hereinafter, manipulation of the adjustable headrest for the seatback according to the present disclosure will be described.

When the position of the headrest in the upper and lower direction and/or in the front and rear direction need to be adjusted, the knob 103a is turned. Turning the knob 103a rotates the driving link 103c, which pushes the locking plate 101 to the right and to eject the locking rod 101c from the locking hole of the fixation rail 301, allowing the body 1 of the headrest T to be in the release state with respect to the fixation rail 301. At the same time, under the pushing of the locking plate 101, the locking pin 202 of the front/rear movement module 20 moves to the right and departs from the catching groove of the locking frame 203, which also allows the front/rear movement module 20 to be in the release state. In this case, the body 1 of the headrest is moved in the up and down direction and the forward and backward direction to adjust the position of the body 1 of the headrest T in the up and down direction and in the forward and backward direction. When the knob 103a is released after the adjustment is completed, the locking plate 101 pushes the locking plate 101 to move to the left by actuation of the restoration force of the spring 103d to allow the locking rod 101c to be inserted into the fixation hole of the fixation rail 301 again. At the same time, as the locking pin 202 is also moved to the left and caught in the catching groove of the locking frame 203, the headrest body 1 becomes the locking state and does not move in the up and down direction and the forward and backward direction.

Hereinabove, the present disclosure is described with reference to the exemplary embodiment in conjunction with the drawings, but a structure of the present disclosure may also be changed. For example, in exemplary embodiment, the driving link 103c is driven to be eccentrically rotated by the knob to allow the locking plate 101 to move straightly and be released. As a modification thereof, a pushing rod is provided to directly push the locking plate 101 to the left/right and to lock/release the locking/release assembly. Further, in the exemplary embodiment, the present disclosure is manipulated manually. However, as a modification, the present disclosure may also be manipulated using an electric adjustment scheme with an electric motor. For example, the locking rod 101c/the locking frame 203 are moved in the left and right/forward and backward directions by driving a screw and a nut using the electric motor.

The adjustable headrest for the seatback according to the present disclosure can implement various adjustment functions of an integrated seat by improving a disadvantage of the headrest adjustment scheme of the integrated seat in the related art, and makes a seat function convenient by improving the locking/release scheme of the headrest in the related art. The fixation scheme of the headrest and a rear frame is optimized to maintain a smooth movement and facilitate the adjustment function of the headrest.

The seatback of the present disclosure may also be used not only for a vehicle seatback but also for backs of other seats. For example, other seats are seats of other transportation means (e.g., ships, airplanes, etc.) and seats of other fixation positions (e.g., office seats).

In order to better interpret and accurately limit the appended claims, the terms “upper”, “lower”, “inside”, “outside”, “up”, “down”, “front”, “rear”, “behind”, “inner side”, “outer side”, “inwards”, “outwards”, “internal”, “external”, “forward”, and “backward” are used for describing features of exemplary implement examples by referring to the positions of the features. In the application documents of the present disclosure, forward, backward, left, right, etc., are all positions determined with respect to the user, and for example, forward means a direction facing the front of the user and backward means a direction facing the rear of the user.

The description of the specific exemplary embodiment of the present disclosure is used for explanation and description. The above explanation is not comprehensive or does not intend to limit the present disclosure to a known exact form, and it is apparent that some modifications and changes can be made according to the above implication. In order to interpret the specific principles of the present disclosure and the actual application, the exemplary embodiments are selected and described, and those skilled in the art can use various exemplary embodiments, and various replaceable methods and modification methods of the present disclosure. The scope of the present disclosure is limited by the appended claims and a form equivalent thereto.

What is claimed is:

1. An adjustable headrest for a seatback, comprising:
a body; and an operating module,
wherein the operating module is connected to the body, and is configured to drive the body to move in up and down direction and forward and backward direction with respect to the seatback, and
the operating module comprises a locking/release module, a front/rear movement module, and an up/down movement guide rail module,
wherein the locking/release module is configured to control a state of the body with respect to the seatback such that in a locking state the body is fixed to the seatback and in a release state the body is allowed to move with respect to the seatback,
wherein the front/rear movement module is configured to allow the body to move in the forward and backward direction,
wherein the up/down movement guide rail module is mounted on the seatback, and the locking/release module and the front/rear movement module are connected to the up/down movement guide rail module to move in the up and down direction, and
wherein the locking/release module and the front/rear movement module are mounted inside the body such that in the release state the body is allowed to move in the up and down direction and the forward and backward direction through the locking/release module and the front/rear movement module.

2. The adjustable headrest of claim 1, wherein the locking/release module comprises:
a lower plate,
a locking plate mounted on the lower plate and moving in left and right direction to lock the locking/release module to the up/down movement guide rail module, and
a driving assembly provided on the lower plate and driving the locking plate to move.

3. The adjustable headrest of claim 2, wherein:
a guide groove is provided on the lower plate, a concave facing downwards is provided at a middle portion of the lower plate, and a through-hole is provided on a bottom of the concave,
the locking plate comprises a movement frame, a guide rod, and a locking rod, wherein the guide rod is mounted on the guide groove of the lower plate, and the locking rod is lockable to the up/down movement guide rail module, and
the driving assembly comprises a knob, a rotary shaft, a driving link, and a torsion spring, wherein the knob is positioned below the concave of the lower plate, the rotary shaft penetrates upwards through the through-hole of the concave, one end of the rotary shaft is fixedly connected to the knob, the other end of the rotary shaft is fixedly connected to the driving link, a lever is provided on the end portion of the driving link opposite to the rotary shaft, and the lever is in contact with an inner side of the movement frame to push the movement frame to move the locking plate.

4. The adjustable headrest of claim 3, wherein the up/down movement guide rail module comprises:
a pair of fixation guide rails, each having a C-shaped cross-section, fixed onto the seatback, having a plurality of locking holes, and allowing the locking/release module to be locked with respect to the up/down movement guide rail module by inserting the locking rod into the locking hole; and
a pair of movement guide rails mounted in the fixation guide rail, movable with respect to the fixation guide rail, and fixedly connected to the lower plate of the locking/release module and the front/rear movement module.

5. The adjustable headrest of claim 4, wherein the up/down movement guide rail module further comprises a first ball set provided between the fixation guide rail and the movement guide rail.

6. The adjustable headrest of claim 5, wherein the first ball set comprises a frame and a plurality of balls positioned at both sides of the frame.

7. The headrest of claim 3, wherein:
the front/rear movement module is positioned above or below the locking/release module, and the front/rear movement module comprises a cover plate, a locking pin, and a locking frame, and
wherein a concave groove is provided at a middle portion of the cover plate, and an opening is provided at a lower end of the concave groove,
the locking pin and the locking frame are accommodated in the concave groove,
the locking frame is one hollow frame and movable in the forward and backward direction with respect to the cover plate,
a plurality of catching grooves is provided at one side of the locking frame, and both front and rear ends of the locking frame is fixedly connected to the body, and
the locking pin is fitted into an outer side of the locking frame and movable in the left and right direction with respect to the locking frame, and a pin matching the catching groove of the locking frame is provided at one side of the locking pin.

8. The adjustable headrest of claim 7, wherein:
the locking plate further comprises a step portion, and the step portion is provided between the guide rod and the locking rod, and
a protrusion is provided at a lower side of the locking pin, the protrusion is matched with the step portion of the locking plate such that the locking pin is pushed in the left and right direction when the locking plate moves to allow the pin of the locking pin to be fitted into the catching groove of the locking frame or departed from the catching groove.

9. The adjustable headrest of claim 8, wherein:
the front/rear movement module further comprises a second ball set, and a rail matching the second ball set is provided at one or more of both upper and lower sides of the locking frame.

10. The adjustable headrest of claim 9, wherein the second ball set comprises a ball bracket and a ball.

11. The adjustable headrest of claim 2, wherein:
the operating module further comprises a frame, and
wherein the frame is mounted on the seatback and connected respectively to the frame of the seatback and the fixation guide rail.

12. The adjustable headrest of claim 1, wherein:
the body comprises a headrest covering and a front/rear inner cover, and
wherein the headrest covering is provided on the outermost side of the body, the front/rear inner cover is positioned on the inner side of the headrest covering, an accommodation space is formed inside the front/rear inner cover to accommodate the operating module, and the front/rear inner cover is connected to the front/rear movement module to move the body.

13. The adjustable headrest of claim 12, wherein the body further comprises an external foam that is positioned between the headrest covering and the front/rear inner cover.

14. The adjustable headrest of claim 12, wherein the body further comprises a front/rear lower cover that is assembled with the headrest covering.

15. An adjustable headrest for a seatback, comprising:
a body;
a locking release module inside the body;
a front/rear movement module inside the body; and
an up/down movement guide rail module,
wherein the locking/release module is configured to fix the body to the seatback when locked and allow it to move when released,
wherein the front/rear movement module is configured to allow the body to move in the forward and backward direction with respect to the seatback, and
wherein the up/down movement guide rail module is mounted on the seatback, and the locking/release module and the front/rear movement module are connected to the up/down movement guide rail module to move in the up and down direction with respect to the seatback.

16. The adjustable headrest of claim 15, wherein the locking/release module comprises:
a lower plate,
a locking plate mounted on the lower plate and moving in left and right direction to lock the locking/release module to the up/down movement guide rail module, and
a driving assembly provided on the lower plate and driving the locking plate to move.

17. The adjustable headrest of claim 16, wherein:
a guide groove is provided on the lower plate, a concave facing downwards is provided at a middle portion of the lower plate, and a through-hole is provided on a bottom of the concave,
the locking plate comprises a movement frame, a guide rod, and a locking rod, wherein the guide rod is mounted on the guide groove of the lower plate, and the locking rod is lockable to the up/down movement guide rail module, and
the driving assembly comprises a knob, a rotary shaft, a driving link, and a torsion spring, wherein the knob is positioned below the concave of the lower plate, the rotary shaft penetrates upwards through the through-hole of the concave, one end of the rotary shaft is fixedly connected to the knob, the other end of the rotary shaft is fixedly connected to the driving link, a lever is provided at an end portion of the driving link opposite to the rotary shaft, and the lever is in contact with an inner side of the movement frame to push the movement frame to move the locking plate.

18. The adjustable headrest of claim 17, wherein the up/down movement guide rail module comprises:
a pair of fixation guide rails, each having a C-shaped cross-section, fixed onto the seatback, having a plurality of locking holes, and allowing the locking/release module to be locked with respect to the up/down movement guide rail module by inserting the locking rod into the locking hole; and
a pair of movement guide rails mounted in the fixation guide rail, movable with respect to the fixation guide rail, and fixedly connected to the lower plate of the locking/release module and the front/rear movement module.

19. The headrest of claim 18, wherein:
the front/rear movement module is positioned above or below the locking/release module, and the front/rear movement module comprises a cover plate, a locking pin, and a locking frame, and
wherein a concave groove is provided at a middle portion of the cover plate, and an opening is provided at a lower end of the concave groove,
the locking pin and the locking frame are accommodated in the concave groove,
the locking frame is one hollow frame and movable in the forward and backward direction with respect to the cover plate,
a plurality of catching grooves is provided at one side of the locking frame, and both front and rear ends of the locking frame is fixedly connected to the body, and
the locking pin is fitted into an outer side of the locking frame and movable in the left and right direction with respect to the locking frame, and a pin matching the catching groove of the locking frame is provided at one side of the locking pin.

20. An adjustable headrest for a seatback, comprising:
a body;
a locking release module inside the body, the locking release module comprising:
a lower plate,
a locking plate mounted on the lower plate and moving in left and right direction to lock the locking/release module to the up/down movement guide rail module, and
a driving assembly provided on the lower plate and driving the locking plate to move;
a front/rear movement module inside the body, the front/rear movement module comprises:
a pair of fixation guide rails, each having a C-shaped cross-section, fixed onto the seatback, having a plurality of locking holes, and allowing the locking/release module to be locked with respect to the up/down movement guide rail module by inserting the locking rod into the locking hole, and a pair of movement guide rails mounted in the fixation guide rail, movable with respect to the fixation guide rail, and fixedly connected to the lower plate of the locking/release module and the front/rear movement module; and
an up/down movement guide rail module positioned above or below the locking/release module, and comprising:
a cover plate,
a locking pin, and
a locking frame,
wherein the locking/release module is configured to fix the body to the seatback when locked and allow it to move when released,
wherein the front/rear movement module is configured to allow the body to move in the forward and backward direction with respect to the seatback, and
wherein the up/down movement guide rail module is mounted on the seatback, and the locking/release module and the front/rear movement module are connected to the up/down movement guide rail module to move in the up and down direction with respect to the seatback.
